(19) United States
(12) Patent Application Publication
(10) Pub. No.: US 2013/0266382 A1
(43) Pub. Date: Oct. 10, 2013

(54) APPARATUS FOR THE TREATMENT OF PLASTICS MATERIAL CONTAINERS WITH FRICTION-REDUCING GUIDE DEVICES

(71) Applicant: KRONES AG, Neutraubling (DE)

(72) Inventors: Johann Huettner, Mallersdorf-Pfaffenberg (DE); Martin Seger, Neumarkt i. d. Oberpfalz (DE); Franz-Xaver Karl, Sinzing (DE)

(73) Assignee: KRONES AG, Neutraubling (DE)

(21) Appl. No.: 13/860,099

(22) Filed: Apr. 10, 2013

(30) Foreign Application Priority Data
Apr. 10, 2012 (DE) 10 2012 103 080.4

(51) Int. Cl. B65G 11/16

(52) U.S. Cl. CPC B65G 11/163
USPC 406/191

(57) ABSTRACT

An apparatus for the treatment of plastics material containers with a conveying device which conveys the containers along a pre-set conveying path and with a guide device which guides the containers at least locally during the movement thereof along the conveying path. The guide device is arranged such that the containers contact a guide face of the guide device at least for a time and move—in particular in a sliding manner—with respect to the guide face. The guide device has a plastics material at least on the guide face towards the containers, treated by radiation.

The present invention relates to an apparatus for the treatment of plastics material containers. Numerous apparatus for the treatment of plastics material containers are known from the prior art, such as for example labelling devices, filling devices, packing devices, closing means, blow moulding machines and the like. In all these apparatus the plastics material pre-forms or the plastics material containers respectively are conveyed between individual units. In this case guide devices, which contact specific areas of the plastics material pre-forms, such as for example an aperture area, a base area or even a side wall, are also provided in part along these conveying paths.

On the other hand, in order to reduce costs in the production of the plastic bottles, for a long time the weight of the plastics material pre-forms has been reduced and, in addition, the portion of material in the plastics material pre-forms is also constantly increased in part. During the blow moulding and during the stretching of the PET bottles respectively, these saving steps result in sticky bottles, i.e. containers with increased coefficients of friction, as a result of which a poor sliding amongst one another is created. The same problem can also occur when conveying the containers between the containers and the guides, in particular lateral guides which consist of plastics material.

In the case of high-performance plants in particular, the flow of containers is delayed as a result of these phenomena and so a so-called pumping effect can occur. This leads in turn to gaps, for example in a one-piece worm wheel, and thus in the worst case to a stoppage of the plant. Similar problems can also occur in the case of channel guides in an air or pack conveyor. In an air conveyor it is possible that the containers remain stuck on a railing. Tests with other materials such as for example metal, PA, POM etc. have failed in the past as a result of the coefficient of friction of the containers with respect to the PE bottles.

A railing for a device for conveying PET bottles is known from EP 2 404 832 A1. In this case the railing carries a guide insert and a guide face towards the PET bottles touches the PET bottles during the conveying. In this case this guide face touching the PET bottles has a polymer material which at 23° C. has a greater modulus of elasticity than PET and at 100° C. has a modulus of elasticity lower by less than 20%. The coefficient of friction with the PET containers can be reduced by a shaping of the guide faces in this way,

In particular, at high operating speeds it has been found that it would be desirable in part for these corresponding coefficients of friction to be reduced still further.

The object of the present invention is therefore to make available a conveying device for containers in the framework of a treatment plant for containers, which facilitates a secure and trouble-free conveying of these containers even in the case of sensitive or light plastic bottles. These objects are attained according to the invention by the subjects of the independent claims.

Advantageous embodiments and further developments form the subject matter of the sub-claims.

An apparatus according to the invention for the treatment of plastics material containers has a conveying device which conveys the container along a pre-set conveying path and a guide device which guides the containers at least locally during the movement thereof along the conveying path, this guide device being arranged in such a way that the containers contact a guide face of this guide device at least for a time and move in a sliding manner with respect to this guide face. In this case the guide device has a plastics material at least on the guide face towards the containers.

According to the invention the guide face of the guide device towards the containers has a plastics material treated (in particular pre-treated) by the action of radiation. In particular, an outer surface of the containers contacts the guide device. It is preferable for the guide device or the plastics material of the guide device to have been irradiated with beams which have an amount of (quantum) energy of more than 100 keV, preferably of more than 150 keV. In this case it is possible first of all for a plastics material to be irradiated and then for the individual guide devices to be produced from this irradiated plastics material. It would also be possible, however, for the guide device to be produced first and for it then to be irradiated (at least locally). It is advantageous for the guide device to be a guide device arranged in a stationary manner.

The treatment of the plastics material pre-forms can be a treatment which is chosen from a group of treatments which includes the blow moulding of plastics material pre-forms into containers, the heating of plastics material containers, the cooling of plastics material containers, the sterilization of plastics material containers, the cleaning of plastics material containers, the filling of plastics material containers, the closing of plastics material containers, the labelling of plastics material containers and/or the conveying of plastics material containers or the like.

The Applicants have found that plastics materials which have been treated by radiation in this way, in particular plastics materials cross-linked by radiation, have a considerably improved property, in particular with respect to the frictional properties. The irradiation of plastics materials in this way has already been known for a relatively long time. Originally a suitable insulation material for cables was sought. In this case it was discovered that the irradiation of specific plastics materials by radiation induces a cross-linking of the plastics material and, in addition, also a degradation of polymers. Cross-linking was originally understood as being a reaction in which a plurality of individual macromolecules are linked to form a three-dimensional network. In this case the properties of the materials change. The aim is to impart a greater degree of hardness or even temperature resistance for example to polymer materials in this case.

As well as the actual base bodies such as for example bottles, plastics material containers are also understood as being the appurtenances thereof such as, in particular, the closures thereof. The invention is therefore like-wise capable of being applied to a conveying device for the conveying of container closures such as for example furrows, in which the closures can slide, or even conveyor plates for container closures. In addition, the invention is capable of being applied to packages of a plurality of containers or even to apparatus which convey for example crates of beverages. In general, therefore, the invention is capable of being applied to conveying devices for the conveying of bulk material, this bulk material also resulting in the movement of this bulk material.

It is advantageous for a precisely determined amount of energy to be introduced into the plastics material during the radiation treatment, in which case for example use can be made of electron accelerators of different power (for beta rays) or even a cobalt-60 source (for gamma rays).

The Applicants have established that this action of ionizing radiation is also harmless for the treatment of foodstuffs, since no radioactivity is produced by ionizing radiation in plastics materials themselves.

In the case of an advantageous embodiment the guide device has a carrier which can consist for example of stainless steel or aluminium. The plastics material element treated by radiation and described above is arranged on this carrier. In addition, it would also be possible, however, for the guide element itself to be able to have a fastening element for arrangement on a carrier, such as for example a rail or the like.

The plastics material containers are, in particular, PET containers. It is preferable for the radiation treatment of the plastics materials to be in particular a cross-linking by gamma and/or beta rays. It is therefore advantageous for at least the guide face towards the containers to have a plastics material treated by radiation. In the case of a further advantageous embodiment the guide device is formed from at least two components.

An essential difference between these two types of radiation lies in the penetration capacity and the dose rate. In plants with electron accelerators, the operation is carried out with high dose rates, but with a limited depth of penetration dependent upon the energy. Even relatively large components can have electrons radiated through them by the accelerator plants with high electron energy which in the meantime have become available.

Gamma rays on the other hand have a high penetration capacity with a relatively low dose rate. In terms of the application this means that in the electron accelerators the dose is applied within a period of seconds to the material to be radiated, whereas several hours are necessary for this in a gamma plant.

In particular, in the case of moulded parts of compact design, gamma rays can in turn have a major advantage. It is advantageous for electron beams to be used in the irradiation of the material.

In the case of an advantageous embodiment the guide face of the guide device towards the containers has a plastics material treated by the action of gamma and/or beta radiation. This means that it is not absolutely necessary to irradiate the entire guide element, but in all events essentially that surface which subsequently comes into contact with the plastics material container.

It is preferable for the above-mentioned guide face towards the containers to have a material cross-linked by the aforesaid radiation.

In the case of an advantageous embodiment the guide device has the radiation pass through it. It is advantageous for the guide device to consist of a homogeneous material which is preferably formed in the same way on the outside as on the inside.

In the case of electron irradiation during the penetration of a polymer these electrons are braked and they impart kinetic energy to the material by way of a cascade of secondary electrons. After that, the macromolecules break up statically into radicals which cause the cross-linking with further macromolecules. In this way for example, plastics material polyethylene (PE) or polyamide (PA) can be directly converted into substances with improved heat deformation resistance at relatively high temperatures of use. In addition, however, it has also been possible to establish that the abrasion resistance increases, and this is important in particular in the scope of the present statement of objects.

In the scope of the production process it is possible for the plastics material parts irradiated in this way to be further processed immediately after the irradiation thereof.

It is preferable for a plastics material already reinforced by other materials also to be used; for example a plastics material which has already been mixed with glass fibres or functional additives. The cross-linking by radiation is independent of reinforcement means of this type.

In the case of a further advantageous embodiment the material is chosen from a group which includes polyethylene (PE), polyether/ether ketones (PEEK), polyoxymetylene (POM), and in particular ultra-high-molecular-weight polyethylene (UHMWPE), PP (polypropylene), PA (polyamide)—in particular PA46, PA6, PA6.6, PA11 or PA12−, PBT (polybutyl ether phthalate), PMP (polymethylpentene) and the like. In addition, combinations of these materials can also be used.

It is advantageous for the material of the guide device, in particular the material of the guide device cross-linked by radiation, to have added to it at least one further component and, in particular, a further material. It is advantageous for the addition of this further material to produce an improvement in the sliding properties of the guide device. In the case of a further advantageous embodiment the further component is a component on the basis of carbon and, in particular, graphite.

In addition, it is also possible for components such as CFRP (carbon-fibre-reinforced plastics) or GFRP (glass-fibre-reinforced plastics) to be used.

In the case of a further advantageous embodiment the material of the guide device has added to it a further component in order to promote the cross-linking. It is advantageous for this further component to be added in a resin. It is advantageous for this further component to be a cross-linking reinforcement means.

It is advantageous for the apparatus to have a channel guide for the bulk material to be conveyed, for example containers or container packages. In this case the material according to the invention can be present in the case of lateral guides of air conveyors, bottle conveyors and package conveyors and preferably consists of cross-linked UHMWPE.

In particular, the above-mentioned problem of the sticking of containers can be improved or even prevented by the cross-linking of the UHMWPE profiles. In the cross-linking the profiles are subjected in particular to gamma or beta rays. As mentioned above, the chains of molecules are cross-linked or welded by these treatments of the guide or the profiles. Sticking of the containers to these guide devices or profiles is thus made more difficult or prevented. As the Applicants were able to establish in tests, a satisfactory sliding property of the UHMWPE profiles is retained despite irradiation.

In the case of a further advantageous embodiment the material of the guide device has a pre-set proportion of gel. The degree of cross-linking (also referred to as the proportion of gel) can be used in order to show the cross-linking. This proportion of gel is determined in accordance with DIN 16892/120 by boiling for several hours in a suitable solvent (for example formic acid). During this it is determined gravimetrically how great the mass of the cross-linked material is in relation to the total mass. In the same way, a soldering iron test according to the PTS specification is usual for practical rapid tests. It is advantageous for the proportion of gel or the degree of cross-linking to be over 10%, preferably over 30% and in a particularly preferred manner over 50%.

In the case of a further advantageous embodiment the apparatus has a device for pouring liquids into containers. The conveying device described here conveys containers to this device for pouring liquids or away from it.

In the case of a further advantageous embodiment the guide device is a lateral guidance device which contacts the containers at least for a time on at least one portion of their side wall. In particular, the sliding property can be improved by treatment with radiation.

In the case of a further advantageous embodiment a plurality of additional bodies, in particular of substantially spherical bodies, are incorporated at least locally into the material of the guide device. In this way, it is possible for the surface structure of the material to be formed by a plurality of spherical elements or to have one, the elements being embedded in a base material and/or carrier material of the guide device or a guide insert. In this case it is advantageous for these elements, in particular spherical elements, to be produced from a material which is chosen from a group of materials which includes glass or ceramic spheres and the like, preferably unipolar fillers.

In this case it is advantageous for these additional bodies, for example spherical bodies, to have in each case cross-sections or volumes which have a diameter of less than 1 mm, preferably less than 0.1 mm, and in a particularly preferred manner less than 0.01 mm.

It is advantageous for a weight proportion of these spherical bodies with respect to the total material to amount to more than 5%, preferably to more than 10%, and in a particularly preferred manner to more than 20%.

The present invention further relates to a guide device for the guidance of containers, in particular for an apparatus of the type described above. In this case this guide device has a guide face, with respect to which the plastics material containers are capable of being moved—in particular in a sliding manner. In addition, the guide device has a plastics material at least on the guide face towards the containers. It would also be possible, however, for the containers to roll (away) with respect to the guide devices.

According to the invention at least the guide face towards the containers has a plastics material treated by the action of radiation.

It is advantageous for the guide device to be produced by an extrusion procedure and then to be cross-linked by radiation.

It is preferable for the guide device to be chosen from a group of guide devices which includes lateral guidance elements, screw conveyors, slide rails, in particular for air conveying of the containers, gripping elements for gripping the plastics material containers, clamping elements for clamping the plastics material containers and the like. The guide device can therefore contact an outer wall of the containers, a carrier ring of the containers, a thread of the containers and/or a base of the containers.

The gripping elements and the clamping elements in this case are also guide elements in the sense of the invention, since they move with respect to the containers at least during the feed towards the latter. In the case of these gripping elements, however, which are preferably suitable for gripping the plastics material containers at the apertures thereof, the sliding properties are less important than the stability and hardness of the material or, in particular, the tear strength and tensile strength.

In addition, however, the guide device can also be such a guide device which does not contact the containers directly but which preferably contacts further elements which in turn are in contact with the containers. The surface towards the containers is preferably that surface which is directed geometrically (at least for a time) towards the containers. Examples of guide devices of this type are for example guide rails under a conveyor chain, sprocket wheels (for a chain conveyor) or reversing wheels. In addition, they may also be components of guide cams, in particular the upper parts or the lower parts of cams, chain guides for roller-type chains or even, as mentioned above, parts of clamps of conveying star wheels.

In the last-named case the conveying device can be for example a conveying star wheel. In this case conveying star wheels of this type can have a rotatable main body on which a plurality of gripping elements—in particular controllable—are arranged. It is preferable in this case for each of these gripping elements to have at least two gripping levers—in particular one-armed—which are preferably connected at the radially inner ends thereof to the main body. In this case it is possible for these gripping levers to resiliently pre-stressed in an opening setting. In this case control cams (which optionally likewise consist of a plastics material cross-linked by radiation) can be further provided, which engage on the outer faces of associated gripping elements which face away from one another. These control cams can be capable in this case of being set in synchronism, and in particular capable of being rotated.

In general, the materials described here can be used in particular for those elements of a container treatment plant with respect to which the containers move at least for a time. The improvement of the sliding properties described here is particularly relevant in the case of such elements with respect to which other elements move. The Applicants therefore reserve the right to claim protection for a container treatment plant which has a device for the conveying of containers as well as at least one element which preferably participates at least in this conveying movement of the containers directly or indirectly and with respect to which the containers move at least for a time.

The present invention further relates to a method of treating plastics material containers in which the plastics material containers are conveyed by means of a conveying device along a pre-set conveying path and in which the plastics material containers are guided at least for a time during this conveying by a guide device which has a plastics material. In this case at least one outer face of the plastics material containers contacts a guide face of the guide device at least for a time.

According to the invention at least the guide face of the guide device towards the containers has a plastics material treated by the action of radiation. In particular, it is a plastics material which has been irradiated by beta or gamma rays.

Further advantages and embodiments are evident from the accompanying drawings. In the drawings

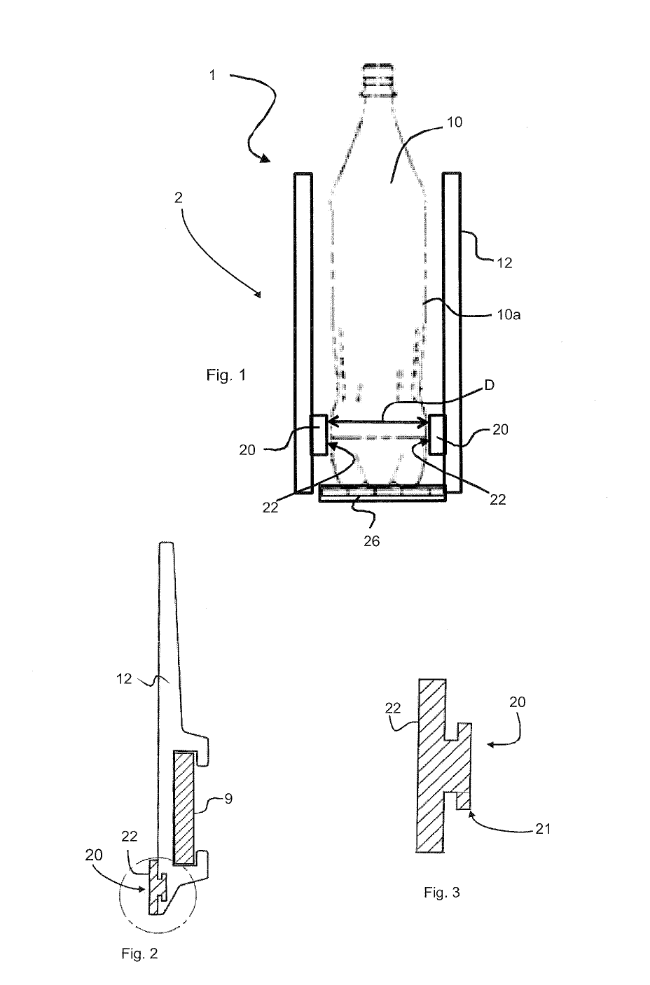

FIG. 1 is a diagrammatic illustration of an apparatus according to the invention;

FIG. 2 is a diagrammatic illustration of a guide device;

FIG. 3 is a detailed illustration of a guide device according to the invention;

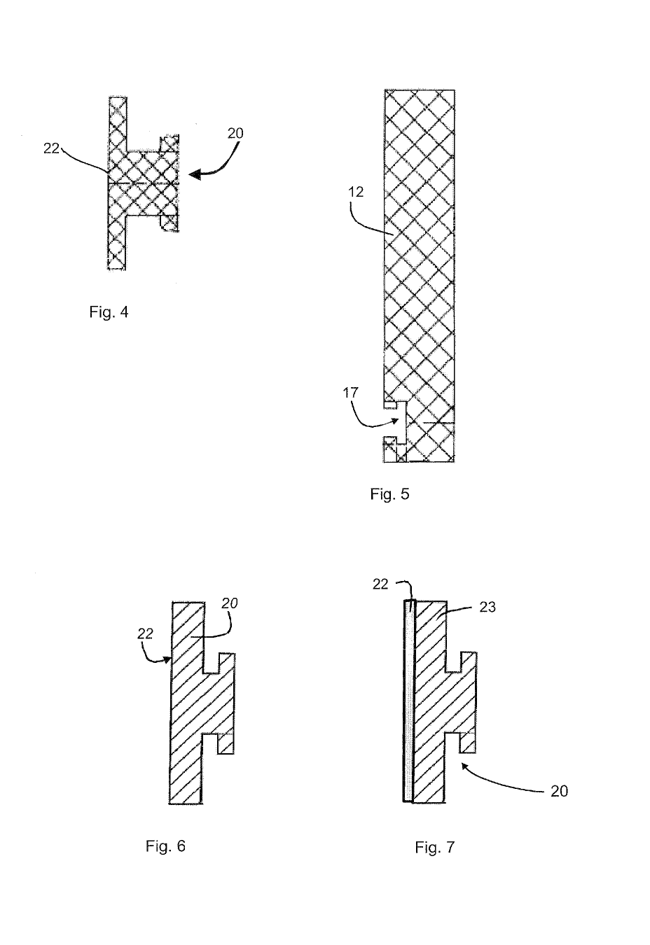

FIG. 4 is a further illustration of a guide device;

FIG. 5 is an illustration of a holding device for a guide device;

FIG. 6 is a further illustration of a guide device according to the invention;

FIG. 7 shows a guide device in a further embodiment;

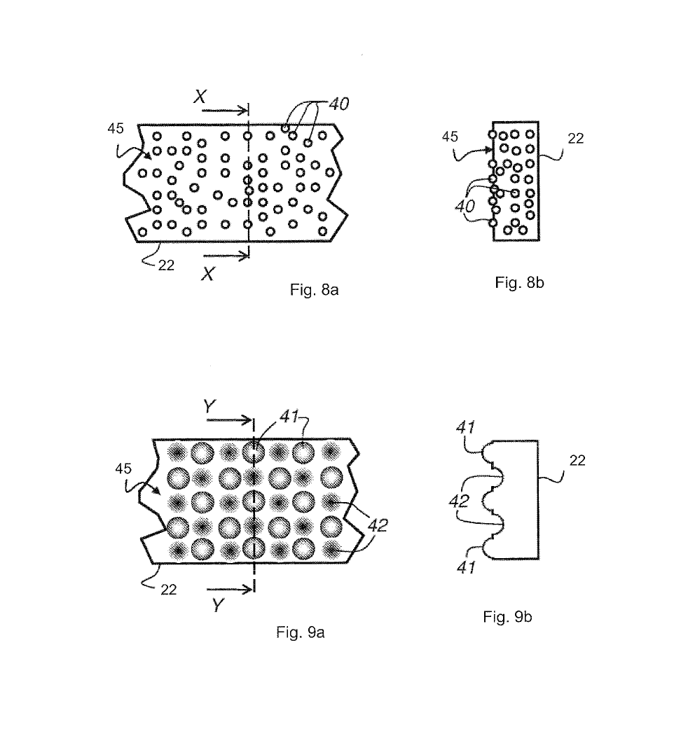

FIGS. 8a, 8b are two illustrations of a material in a preferred embodiment, and

FIGS. 9a, 9b are two illustrations of a material in a second embodiment.

FIG. 1 is a diagrammatic illustration of an apparatus 1 according to the invention for the treatment of plastics material containers. Expressed more precisely, a conveying device 2 for the conveying of containers 10 is shown here. These containers 10 have a side wall 10a. In this case for example the containers 10, which in particular are PET bottles, can be conveyed one behind the other here. In the case of the arrangement shown in FIG. 1 a single-track conveying of these containers 10 is provided. Here these containers are conveyed in this case on a conveyor belt designated 26. Railings or carriers 12, between which the container 10 is guided, are provided at the side in each case. Guide inserts or guide devices 20, the guide faces 22 of which touch the containers 10, are arranged on these railings 12. These two guide devices 20 thus form a channel in this case in which containers 10 are guided.

In certain applications it may also be sufficient for only one of the two guide devices 20 to be provided, i.e. only on one side. In this case the guide devices 12 prevent the containers from being able to fall off the conveyor belt 26. The invention shown in FIG. 1 would also, however, be capable of being used in other apparatus, for example in those applications in which containers (filled or empty) are conveyed suspended on their carrier ring. The reference 10a refers to an outer wall of the containers. The reference letter D designates a distance between the two guide devices or a distance between the two guide faces 22 thereof. This distance is adapted in this case to a diameter of the container or is chosen to be slightly larger than the latter.

FIG. 2 is a possible illustration of a guide device 20 which in this case is arranged on a carrier 12. In this case a carrier element 9 can also be provided which in turn holds the carrier 12. This carrier element 9 can also be used for the mechanical stabilization of the carrier 12. In this case it is possible for this carrier element to be made resilient.

FIG. 3 is an enlarged illustration of the guide device 20. In this case the reference number 22 designates the guide face which is towards the containers. In particular, in the region of this guide face 22 the plastics material of the guide device 20 is produced from a plastics material cross-linked by radiation. The reference number 21 designates a holding device or an assembly structure by which the guide device 20 can be arranged on the carrier 12, for example can be inserted into the latter.

FIGS. 4 and 5 show a further embodiment of a guide device 20. In this case the carrier 12 is designed in the form of a plate in which a recess or negative shape 17 is provided for receiving the holding device 21 of the guide device 20.

FIG. 6 shows a further embodiment of the guide device with the guide face 22. In this case the entire guide face 22 is formed from a homogeneous material such as in particular UHMWPE. In this way, this material is also present on the guide face 22 which contacts the containers.

In the case of the embodiment shown in FIG. 7 the guide device 20 is formed in two parts and has a main body 23 on which the guide face 22 is arranged as a layer or coating 22. In this way, the costs can be reduced, since a more economical material can be used for the main body 23. In this case it is possible for only the guide face 22 to consist of an irradiated plastics material.

FIGS. 8a, 8b show a further design of a material according to the invention. Here a plurality of substantially spherical bodies 40 in this case are embedded in the main body 45 of the material. FIG. 8b is a view of the body from FIG. 8a along the arrows X-X from FIG. 8. It is evident that in this case a contact face is formed by these individual spherical bodies 40. The raised portions which are produced by the spherical bodies 40 are shown hemispherical here, but the invention is not restricted to these. As a whole, however, an undulating guide face is produced in this way and it has been possible to show that this undulating guide face reduces the coefficient of friction of the guide device and the guide face 22 respectively.

In general, it is preferable for this embedding of the spherical bodies also to be combined with a cross-linking of the plastics material by radiation. Furthermore, additional reinforcement elements can also be provided which reinforce the material of the plastics material as a whole.

FIGS. 9a, 9b show a further embodiment in which raised portions 49 and/or depressions 42 are provided in the material. In this case these raised portions and depressions can also be provided in the form of uniform furrows or grooves or with a different profiling. As a whole, it is made possible by this that the resulting guide face of the guide device or the guide face 22 respectively has a smaller support face as a whole in the contact region with the plastics material containers.

The Applicants reserve the right to claim all the features disclosed in the application documents as being essential to the invention, insofar as they are novel either individually or in combination as compared with the prior art.

List of References

1 apparatus

2 conveying device

9 carrier element

10 containers

10a side wall

12 carrier

17 recess

20 guide devices

21 holding device

22 guide face

23 main body

26 conveyor belt

40 spherical body

41 raised portions in the material

42 depressions in the material

45 main body of the material

D distance

1. An apparatus for the treatment of plastics material containers with a conveying device which conveys the containers along a pre-set conveying path and with a guide device which guides the containers at least locally during the movement thereof along the conveying path, wherein this guide device is arranged in such a way that the containers contact a guide face of this guide device at least for a time and move—in particular in a sliding manner—with respect to this guide face, wherein the guide device has a plastics material at least on the guide face towards the containers, wherein the guide face of the guide device towards the containers has a plastics material treated by the action of radiation.

2. The apparatus according to claim 1, wherein at least the guide face of the guide device towards the containers has a plastics material treated by the action of gamma or beta radiation.

3. The apparatus according to claim 2, wherein the guide device has the radiation pass through it.

4. The apparatus according to claim 1, wherein at least the guide face towards the containers has a material cross-linked by the radiation.

5. The apparatus according to claim 1, wherein the plastics material is selected from the group consisting of PE, PEEK, POM, UHMWPE, PP, PA—in particular PA46, PA6, PA6.6, PA11 or PA12−, PBT, PMP, and a combination thereof.

6. The apparatus according to claim 1, wherein the material of the guide device has a pre-set proportion of gel.

7. The apparatus according to claim 6, wherein the proportion of gel is over 10%.

8. The apparatus according to claim 1, wherein the apparatus includes a device for pouring liquids into containers.

9. The apparatus according to claim 1, wherein the guide device is a lateral guidance device which contacts the containers at least for a time on at least one portion of their side wall.

10. The apparatus according to claim 1, wherein a plurality of substantially spherical elements are incorporated at least locally into the material of the guide device.

11. A guide device for the guidance of containers, in particular for an apparatus according to claim 1, wherein this guide device has a guide face, with respect to which the plastics material containers are capable of being moved in a sliding manner, and wherein the guide device has a plastics material at least on the guide face towards the containers, wherein at least the guide face towards the containers has a plastics material treated by the action of radiation.

12. The guide device according to claim 11, wherein the guide device is selected from the group consisting of guide devices which include lateral guidance elements, screw conveyors, slide rails, gripping elements for gripping the plastics material containers, and clamping elements for clamping the plastics material containers.

13. A method of treating plastics material containers, wherein the plastics material containers are conveyed by a conveying device along a pre-set conveying path and wherein the plastics material containers are guided at least for a time during this conveying by a guide device which has a plastics material, wherein at least one outer face of the plastics material containers contacts a guide face of the guide device at least for a time, wherein the guide face of the guide device towards the containers has a plastics material treated by the action of radiation.

14. The apparatus according to claim 6, wherein the proportion of gel is over 30%.

15. The apparatus according to claim 6, wherein the proportion of gel is over 50%.
